(19) United States
(12) Patent Application Publication
(10) Pub. No.: US 2008/0255754 A1
(43) Pub. Date: Oct. 16, 2008

(54) Traffic incidents processing system and method for sharing real time traffic information

(76) Inventor: David Pinto, Rockville, MD (US)

Correspondence Address: HOLLAND & KNIGHT LLP, 2099 PENNSYLVANIA AVE, SUITE 100, WASHINGTON, DC, 20006, US

(21) Appl. No.: 11/783,867

(22) Filed: Apr. 12, 2007

(51) Int. Cl. G06F 19/00

(52) U.S. Cl. 701/119; 701/117

(57) ABSTRACT

A traffic incidents processing system for sharing real time traffic information between a plurality of users connected via a network. The system includes a central computer system, operatively connected to a wide area network such as the Internet, a multiplicity of mobile communication devices, capable of determining their geographical location, and are operatively connected to a wide area network such as the Internet, and are capable of transmitting location based traffic information to the said central computer system. The central computer system continuously maintains updated database of traffic information. The central computer system is capable of analyzing, screening and assessing the reliability of the traffic information, detect a traffic situation, and provide customized, real time traffic alerts to a plurality of users connected to a network and to mobile communication devices such as cellular telephones via the wide area network as well as via short messaging service SMS, multimedia messaging system MMS, or any other data protocol capable of communicating with mobile devices. The central computer system is further capable of storing a history of routes traveled by users, and determine an optimal route from any originating point to any destination point by analyzing the stored routes and construct the optimal route using the most frequently traveled segments found in the stored routes database, and the realtime traffic information that is known to the system.

### FIELD OF THE INVENTION

The present invention relates to traffic incidents and in particular, a method and a system for exchange and communication of traffic and road information using mobile communication devices.

### BACKGROUND OF THE INVENTION

Much of the traffic incidents are caused by obstructions to the normal flow of traffic. In many of the large urban areas, the number of vehicles traveling on the road during the rush hours is exceeding the road network capacity. Accordingly, any obstruction to the flow creates a traffic condition, resulting in slowed traffic flow, traffic jams and at times, gridlock.

Some of these obstructions, or traffic incidents are known in advance, e.g., planned road work etc., yet the majority are unplanned. Even those that are planned in advance may not be known to many of the drivers who failed to tune in to news or other traffic reports from the media prior to their commute. The media tries to deliver information about traffic incidents to the commuting public, yet the sources of the information available to the media for unplanned incidents are limited, and are based on helicopter observation, static traffic sensors and cameras installed on major highways and emergency services reports.

The current means mentioned above for obtaining information regarding unplanned traffic incidents are limited mainly due to cost. Helicopter deployment is typically limited to very few helicopters per metroplex, which is insufficient and can provide real time coverage only for few routes at a time. Cameras and traffic sensors are also expensive to install and maintain, and therefore are deployed only along major highways. It will be beneficial to collect and report realtime traffic information from more roads.

The use of cellular phones for collecting location, direction and speed information is addressed in U.S. Pat. No. 6,615,130. Data is collected from vehicles equipped with “MGU's” Mobile Guidance Units to maintain a real-time travel time on road segments. Other disclosures that are using cellular phones for collecting location, direction and speed information are U.S. Pat. No. 6,490,519, U.S. Pat. No. 6,466,862, U.S. Pat. No. 6,381,533 and U.S. Pat. No. 6,401,027.

Location Based information provided by these inventions is extremely sensitive in nature and includes the location of a user at any given time transmitted between the various components of such systems. This has severe privacy impacts on the user which has slowed or stopped the deployment of these systems.

### SUMMARY OF THE INVENTION

An object of aspects of the invention is to provide a system and method that does not require any identifying information from the users to be obtained, stored or even temporarily accessed.

As drivers travel along roadways, they are the first to encounter incidents that affect the normal flow of traffic on the road network. In addition, drivers are the first to encounter driving conditions that pose potential hazards, such as potholes or other breaks in the pavement, flooded road section etc. An object of aspects of the present invention is to provide a system and method to utilize this information in real time and to share this information with others.

In many cases, drivers have option to choose from multiple routes to travel from their origination point to their destination. By getting real-time information regarding such traffic incidents, and potential hazards, drivers can avoid them entirely or at least have an anticipatory response when encountering these traffic situations. It would be useful to provide a system that allows drivers to report such driving conditions to other drivers and to allow this information to be used by other drivers to dynamically determine the quickest route to work or other destination for any given time.

Aspects of the invention generally relates to sharing location based information between different users. More particularly, this invention relates to a system and method for drivers to proactively share traffic incidents and potentially hazardous driving condition information, using mobile devices connected to a wide area network such as the Internet.

Further, aspects of the invention include systems and methods for proactively alerting the users when a traffic incident was identified on their route, prior to the congestion being built-up as a result of that incident. This enables drivers to take a new route before it is too late to change routes.

According to aspects of the present invention, a vehicle driver carrying a mobile communication device such as a cellular phone, operationally connected to a GPS receiver capable of obtaining geographic position information, will be able to share realtime traffic information with other vehicle drivers, carrying mobile communication devices.

One goal of this invention is to provide the driver with a way to communicate in realtime traffic incidents to other drivers. At any point of the journey, the driver can report a traffic incident to other drivers driving along routes that leads to this incident, therefore allowing them to bypass it.

Another goal is to collect realtime speed information from multiple mobile devices and compile it, along with the incidents information into an accurate, complete and comprehensive representation of the current traffic flow along the road network, and make this information available to subscribed users.

Yet another goal of this invention is to provide the driver an optimal route to a destination by utilizing the realtime traffic information and the history of routes and traffic information that is shared by the drivers and accumulated by the system.

Further goal of this invention is to provide a Location Based system and a service that will not require any identifying information from the subscribed users that may jeopardize their privacy.

### BRIEF DESCRIPTION OF THE DRAWINGS

FIG. 1 is a block diagram of a system and method in accordance with the present invention;

FIG. 2 is a block diagram of the overall system and method in accordance with aspects of the invention;

FIG. 3 is a block diagram of the information server in accordance with aspects of the invention;

FIG. 4 is a pictorial view of a traffic flow and surrounding environment;

FIGS. 5-7 and 11-12 are partial block/partial pictorial views of a system and method in accordance with aspects of the invention;

FIGS. 8 and 9 are pictorial views of traffic flows in accordance with aspects of the invention;

FIG. 10 includes equations which may be utilized by aspects of the invention; and

FIG. 13 is an exemplary flow chart of a reliability calculation;

### DETAILED DESCRIPTION OF THE INVENTION

A goal of this invention is to enable location based traffic information sharing among a community of users. This invention provides the driver with a way to communicate realtime traffic speed and incidents to other drivers. At any point of the journey, the driver can report a traffic incident to other drivers driving along routes that leads to this incident, therefore allowing them to bypass it.

By collecting realtime speed information from multiple mobile devices and compiling it with the incidents information reported by the drivers, the system can provide an accurate, complete and comprehensive representation of the current traffic flow along the road network, and make this information available to subscribed users.

In one embodiment of the present invention, the mobile communication device is operationally connected to the Internet. A software client may be installed on a plurality of mobile device. The software client may be configured to present information to the driver as well accepting input from the driver. The software client may also be capable of collecting position information from a GPS receiver which is connected to the mobile device, establish connection with a web server via the Internet or other suitable network using a suitable protocol and then transmit this information.

According to this aspect of the invention, when the driver is identifying a traffic incident, the driver will use the software client to report the traffic incident to the server by pressing on a key on the mobile device's keyboard or other suitable interaction. The client will obtain the current position information from the GPS receiver and transmit the driver's input along with the position information and the time information to the server via the Internet or other suitable network. The server will process and validate the information, and will send it in a form of traffic alerts to a plurality of other drivers, carrying similar software client enabled modules that are driving on a route leading to this traffic incident.

Further according to aspects of the invention, the software client can constantly collect position information from the GPS receiver, and periodically transmit it to a server or other remote computer, which can use this realtime position information to maintain in a database the travel speed of that device associated with the software client on the road network. The server may compile this information with similar information received from multiple clients to create a realtime database of travel speeds along all road segments traveled by such client.

Still Further according to aspects of the invention, the server may measure the time it takes a user to travel from point A to point B, and if this time longer than the expected time, use the software client that is installed on the user's mobile device to prompt the user using text or voice to confirm that the measured time is reflecting the traffic travel time along the route from point A to point B. This method will eliminate cases in which the vehicle speed was not reflecting the traffic speed in this route, for example due to a mechanical issue. The user will be able to confirm using the mobile device by pressing a key or using her voice.

Still further in this embodiment, the server may maintain a database of historical traffic information, and constantly compare the current speed on the roads network with the expected speed as calculated from the historical traffic information. If the current speed on a road segment falls under the expected speed, the server may identify this in realtime, and will send this information to plurality of other drivers, carrying similar traffic management software clients that are driving on a route leading to this traffic situation.

Further yet in this embodiment, the server may combine realtime reports of traffic incidents received from drivers, with the speed information which it is constantly maintain, and create a complete and comprehensive traffic reports that will be available to users upon request.

Still further aspects of the invention include a Short Messaging Service SMS communication in which a mobile client may communicate with the travel server using SMS. In this manner, the mobile client does not have to utilize internet access from the mobile devices.

Additional aspects of the invention include Mobile Traffic Cameras—Mobile devices equipped with cameras will enable the user to send realtime pictures and videos of traffic. In this manner, other users may be provided with a view of the traffic conditions ahead. For example, the user may have a map of traffic showing on his mobile device's screen. Moving icons on the screen will indicate position of users that are transmitting real time video stream of the traffic in their location. The user may select an icon on that screen to be shown traffic conditions at the position of the selected icon. The screen can then provide a picture (video) of the traffic conditions. This will enable the user to make a rational decision on whether to seek an alternative route. The client software may obtain the current position information from the GPS receiver and transmit the images along with the position information and the time information to the server. The server will collect and make these images available to plurality of other drivers, carrying similar client software.

In additional aspects of the invention, using the software client installed on the mobile device, the user will be able to request the optimal route from point A to point B. The request will be transmitted to the server, which will use historical information as well as current traffic conditions to determine the fastest route. The historical information that the server will use will include the common routes that other users took from the said point A to the said point B, and/or from any point to any point along the route from said point A to said point B. Using historical information to determine a route from point A to point B will provide the user with a better route then a route which can be calculated using any navigation algorithm, it will take into consideration the preferences and route selections made by the users community, which are mainly local drivers who are familiar with the local roads and the best routes to commute on.

In additional aspects of the invention, Voice recognition software is integrated into the client. Commands such as “Report Traffic Incident” followed by “Broken Traffic light”, “Two lanes closed due to road work”, “Accident blocking one lane” etc. will permit the driver to submit traffic data. The client software uses speech recognition technology to translate the voice commands to traffic alerts (e.g., textual and/or graphic) that can be transmitted to the server. In yet another embodiment of the current invention, the client software will record the user's voice commands and will transmit the voice file to the travel server which will analyze the commands and translate them to the corresponding traffic alerts (e.g., textual and/or graphic). Further, the client software may use the commands to help ease the experience for the user. For example, the user may say “Is there a faster route” and the client will query the server and determine the fastest route given the past history of the route traveled combined with the current traffic information.

In yet further aspects of the invention, the user may initiate a request to obtain traffic services using the mobile client. In this manner, the user may broadcast a request to service providers such as roadside assistance, towing services, taxi services etc. The client travel software may be configured to provide the exact user's location, and any service provider, carrying similar mobile device configured with similar client software will be able to tune in to such broadcasts within a preconfigured radius of the service provider's current location. The service provider may pay a fee to be the first one notified of the traffic condition and therefore the first on on-site to assist.

In still further aspects of the invention, the client software may be configured to update a digital map information. Currently, digitals maps are not keeping up with the changes and development of the road network. The system will be able to identify new routes and changes to existing routes by matching actual location information collected from drivers equipped with mobile devices loaded with the client software and convey this information to the server, which will use this information to update the digital map maintained in the server.

Still further aspects of the present invention include a system and method using the client and server software to provide: 1) current wait time at toll booth—the information can be useful for drivers on a route to the toll plaza, as well as the operator of the booth. In addition, this information can be used when calculating the fastest route, e.g., 2) HOV lane speed vs. other lanes and may include the ability to open and close certain lanes and control entry via on-ramps or the length of the queue at an intersection by dynamically controlling the control traffic lights timing, 3) detection of sudden stops or any vehicle behavior that could only indicate an accident, 4) detection of hazardous situations: driver dozing, vehicle veering off of the road—sound a loud alert, proximity to another vehicle at speed, proximity to a stopped vehicle when traveling at speed, and other similar such conditions including where two vehicles equipped with client software are getting too close to one another at a high speed—Alert for potential accident, 5) parking lots occupancy—communicate with local devices installed in the parking lot to direct drivers to the closest lot with vacancies, and within the lot—to the closest spot.

Further embodiments of the current invention will allow users to share additional location based information such as: 1) Gas prices—user stops to fill the tank and use the software client on the mobile device to either click the gas price or take a picture of the current gas price and share this with all the other users, 2) location sensitive coupons—Business owners who want to attract occasional buyers can use the system to submit a coupon that will trigger an alert to users that are passing by their business location and/or passing by during a low demand time and offer special discount to these users only, 3) Police Radars and red traffic light cameras location—drivers can report the location of such devices to other drivers in real time and this alert will be sent to other drivers that are en route to the Police Radar or the red traffic light camera. This alert could include the current maximum speed allowed in this location which will help the driver who may have missed the last sign indicating the maximum speed, 4) “Follow Me”—drivers going on a trip together in two or more vehicles where the first driver is leading the way to the other drivers who are unfamiliar with the route don't need to maintain eye contact, by using the software client installed on her device, the leading driver will enable a “follow me” feature showing to the other vehicles the route that the leading car is taking by painting the route on their maps at all times, 5) Weather information—devices equipped with thermometers, rain gauges, and barometers can provide micro level information to other drivers which will determine likely freezing conditions on certain roads.

In still further aspects of the invention, certain business may use the device to communicate with other individuals within their group. For example, a courier service or taxi service may use the device to determine the current location and their proximity to each other and to a potential client. For example, a Taxi Ride Finder might indicate someone trying to hail a cab. Cabs that are in the customer's vicinity, when notified of a user seeking a cab, will be notified immediately and may then locate the customer. Thus, a cab that is full may immediately notify other cabs in his group in the vicinity by using the mobile device. According to the following embodiment, Taxi drivers which become users of this system, will be able to use their mobile devices in order to share location information with other users of the system.

According to still further embodiments Pedestrians who wishes to get a taxi ride can use the mobile device to broadcast a ride request call by using the software client installed on her mobile device. The client software will obtain the current position information from the GPS receiver and transmit the user's request along with the position information and the time information to the server. The server may then process and validate the information, and send a notification to plurality of taxi drivers, carrying similar mobile clients that are driving within a configurable, predefine radius from the location of the requesting user. The server software at this stage may be configured to only share a general location of the user. The exact location will be shared with the driver only after the requesting user is making a final selection. Taxi drivers who wish to accept the call will notify the system using their mobile devices. The client software may obtain the current position information from the GPS receiver and transmit the Taxi driver's position along with additional information to the client server of the requesting user. The server may charge taxi drivers for this service. Additional information may include: discounts that the driver is willing to offer the rider in order to win the ride, car type and age, any other type of special offer. The server may transmit back to the requesting user the location of the drivers who wish to accept the ride, the approximate time that it would take them to reach his/her location, and the additional information as detailed above. The server may also notify all the drivers that responded to the call of their order in the queue first responding driver is #1, second is #2 in the queue and so forth. In this manner, the requesting users may make a selection from the list of the drivers that accepted the call. The selection may be transmitted back to the server, which will transmit to the selected driver the exact location of the requesting user, and will notify all the other drivers who responded to the call that the ride is taken.

Additional features that this embodiment may include measuring the pick-up location, the traveled distance, and the drop off location as combined with the prevailing rate for taxi cabs. In this manner, the system can determine the charge the taxi driver should have charged you for the fare. This is particularly useful where the user is in a city such as DC without any meters or in a city where drivers typically drive out of the way for out of town fares. Using the system, a user can track the route of the ride, along with all the parameters that are used in calculating the base trip fare and once the ride is completed compare the price that the driver is charging him/her to the system's calculated price. The user can also determine in advance how much a ride should cost. Once again, the system can calculate the price based on all the parameters such as wait time, speed, distance etc that are needed to calculate the ride's fare, taking into consideration also the current traffic information. Any mobile device can thus become a taxicab meter. In order to print a receipt the device can communicate using Bluetooth to a local mini-printer.

Another embodiment of this system may be offered to taxicab companies, which will offer to the dispatcher the following features: 1) ability to intercept all calls from potential riders, and route the request to a taxicab of his/her discretion, 2) realtime information about the transactions in case drivers are allowed to receive such calls, 3) requesting user's location as well as location of cars belonging to the company will be highlighted on the dispatcher's console, 4) the mobile device in the taxi may also be used to calculate the fair based on all the parameters that are needed to calculate the fare time, speed, distance, which are all available and obtainable from the GPS receiver, 5) the fare will be transmitted back to the dispatcher's console and will be recorded for future use.

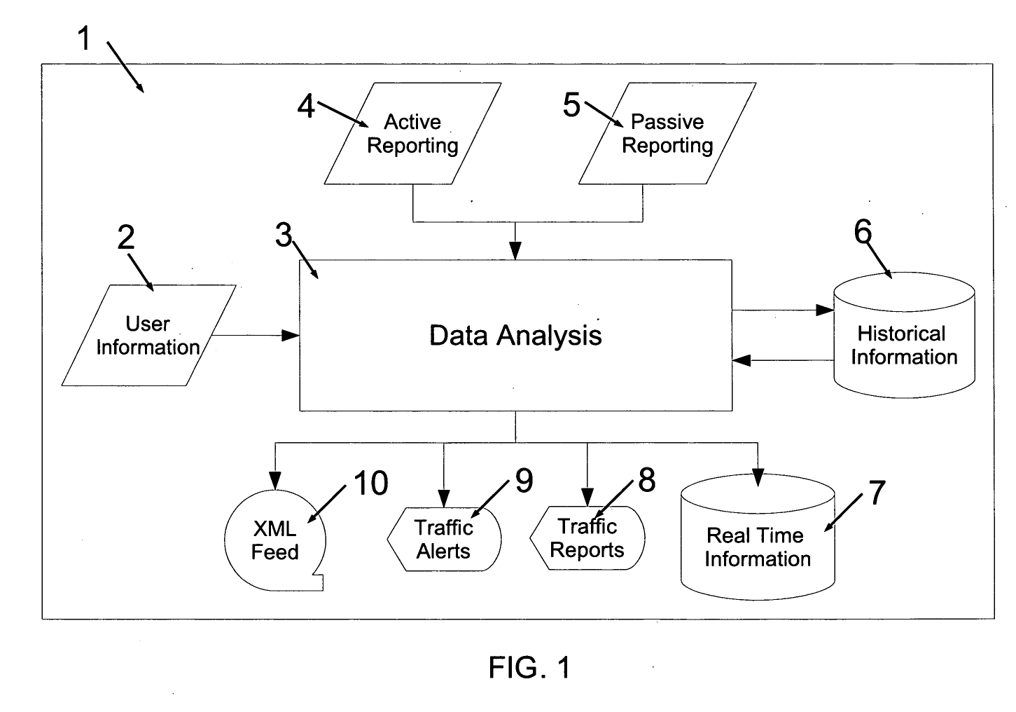

FIG. 1 shows the logical components and processes in the system, and the flow of information between these components. The client software may include inputs such as user information such as non-identifying details such as frequently used routes, make and type of the user's mobile communication device, user's schedule preferences for receiving alerts and traffic reports, and user's preferences for key assignments and audio configuration of the traffic management software client. The client software may include passive reporting software which may include Extended Markup Language XML packets sent from the user's client which are sent while the user is driving on the road network. These packets may be variously configured to contain a time-stamped location, direction and speed information as collected from the GPS receiver. This information may be constantly and/or periodically sent in predefined intervals, and is being used by the system to maintain a database of the current traffic speed and travel times of all road segments; active reporting which may comprise active reporting of traffic incidents, that are sent by the drivers using the client whenever they encounter a traffic incident such as a car accident, stalled car etc., as well as road hazards such as oil spills, flooded sections and other such similar circumstance.

This information may include incident type, and a time-stamped information, all packed in an XML packet sent by the client software. The system analyzes the data and may then send the data to other users. This may be in the form of traffic alerts and/or included as part of traffic reports.

Historical information, which is accumulated by the system, containing travel times for all road segments. Initially, those travel times are reflecting calculated travel times based on known parameters such as the maximum speed limit for the different segments, the number of intersections etc., but as the time passes and real data is being collected and analyzed, they are replaced by actual travel times reflecting realistic travel conditions as observed. This information will by used by the system to establish the expected speed and travel time and such—identify exceptions. In addition to the travel time information, the Historical information data base will contain the accumulation of some or all the routes that were traveled by users. The system may use this information for suggesting to the user the best route from point A to point B by analyzing the most common and frequently traveled routed from said point A to said point B, or from any point to any point between said points A and B.

The above input data is analyzed by the system, and the outputs described below may be created. These outputs may include traffic alerts containing specific information regarding traffic incidents and road hazards, as well as other traffic related information such as police radars. Each traffic alert may include the location on the road network, the direction of the traffic that the incident is affecting, and the severity of the incident. Traffic alerts may be issued following a notification from another user, or by the system, once a traffic slowdown is identified. The traffic alerts may be sent to users based on their recorded preferences, current route and position. In addition, realtime traffic information may be provided by a customized stream of updates such as an XML feed related to the traffic information. Every change in the current traffic information may be sent out via this feed to designated users. In addition, the system may store the realtime traffic information in a database, and provide users with access to such database in order to obtain traffic information in realtime. Such access may be provided via a wide area network such as the internet, using web services and/or other access protocols. Traffic reports about specific routes or geographical areas, e.g., detailing for each road segment the current travel time, and any traffic incident that currently exist, may also be provided to a user's client software. Traffic reports may be provided continuously or periodically according to a schedule set by the user or upon a request generated by a user.

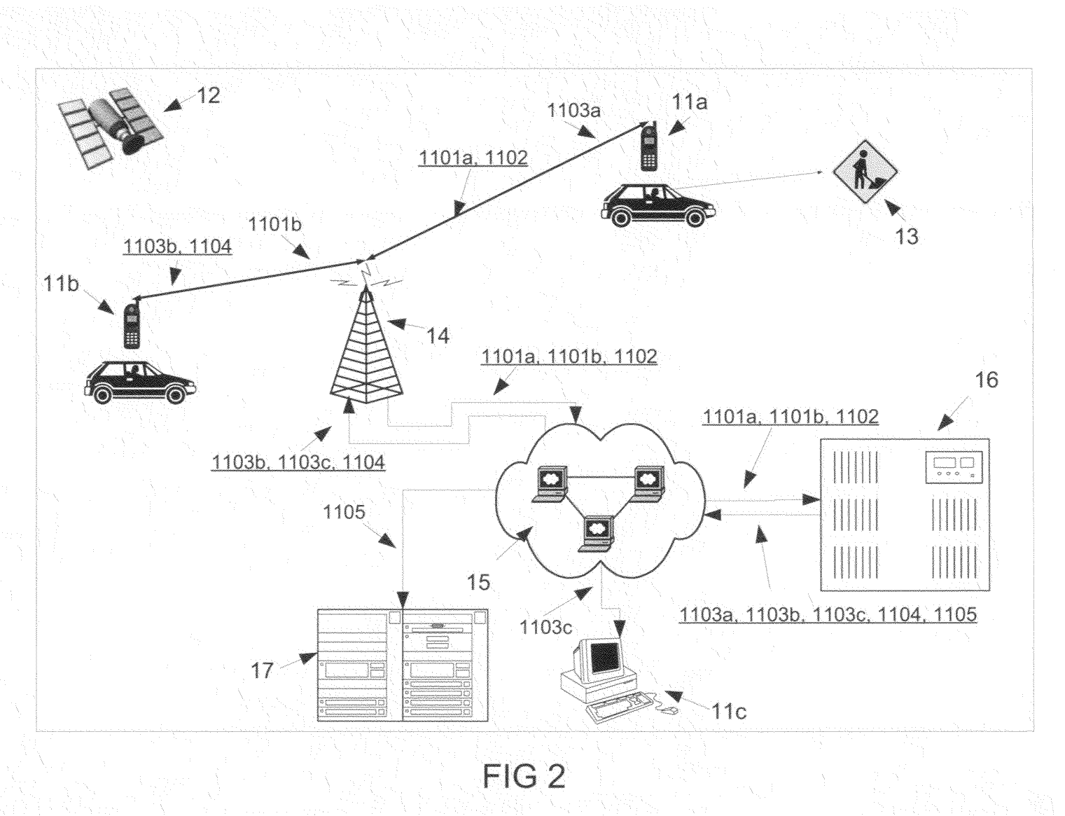

FIG. 2 is a schematic representation of the major components of the system and the flow of data between them. The diagram represents vehicle drivers, equipped with mobile communication devices 11a & 11b which have been preloaded with the client traffic management software, and are capable of receiving the satellite 12 GPS data, and communicating it to the traffic information processing server 16 via the Internet 15. The gateway to the Internet is provided by the telecommunication provider 14. PC users 11c and other computer systems 17 may also connect to the traffic information processing server 16 to obtain Traffic Information. The diagram also demonstrates the flow of the data between the components:

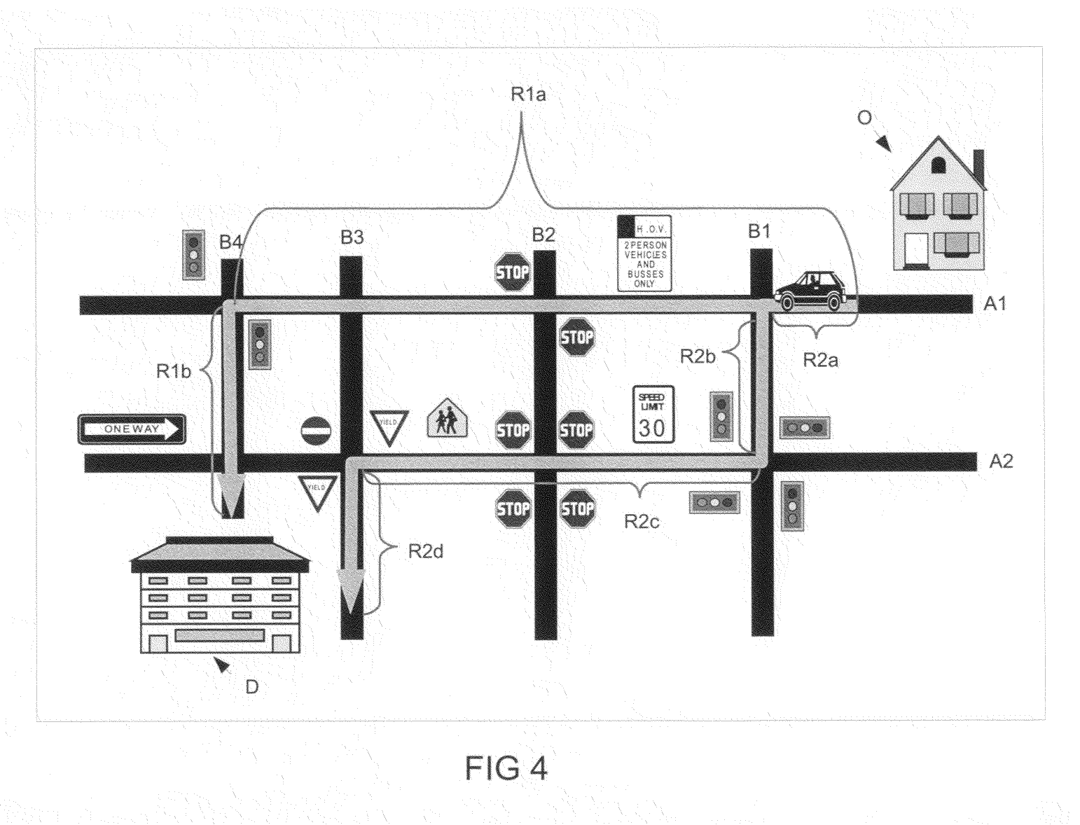

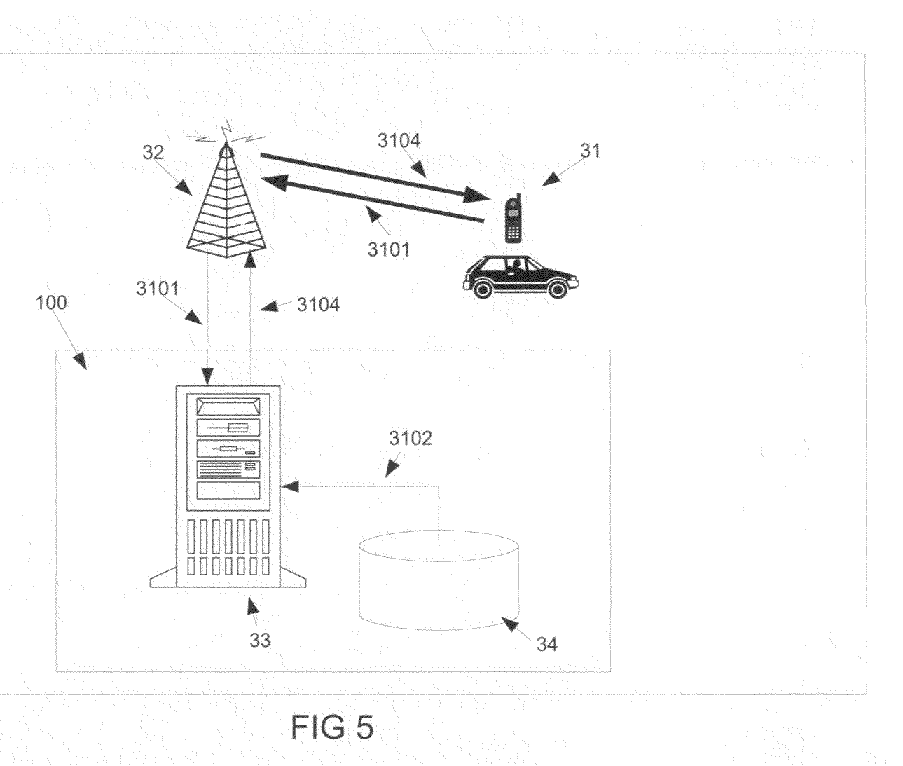

Passive Reporting is presented by 1101a & 1101b, sent from the client traffic managements to the telecommunication carrier. The Telecommunication carrier is piping this information through the Internet to the traffic information processing server 16, which is analyzing and storing the information. Passive reporting is further described in FIG. 4;

Active Reporting is presented by 1102, showing driver 11a identifying a Traffic Incident 13 and submitting a Traffic Incident Report by using his mobile communication device. The client traffic management software is intercepting this information, packing it with position information obtained at that moment from the GPS satellite, and transmits it to the telecommunication carrier. The Telecommunication carrier is piping the traffic information report through the Internet to the traffic information processing server 16, which is analyzing and storing it. Active reporting is further described in FIG. 5;

Traffic Reports are presented by 1103a, 1103b & 1103c, sent from the traffic information processing server 16 via the Internet, which will deliver the reports to the PC user 11c and to the telecommunication carrier which will deliver the reports to the requesting client traffic management software.

Realtime traffic information XML feed is presented by 1105, sent from the traffic information processing server 16 via the Internet to an external computer system to be further processed by that system.

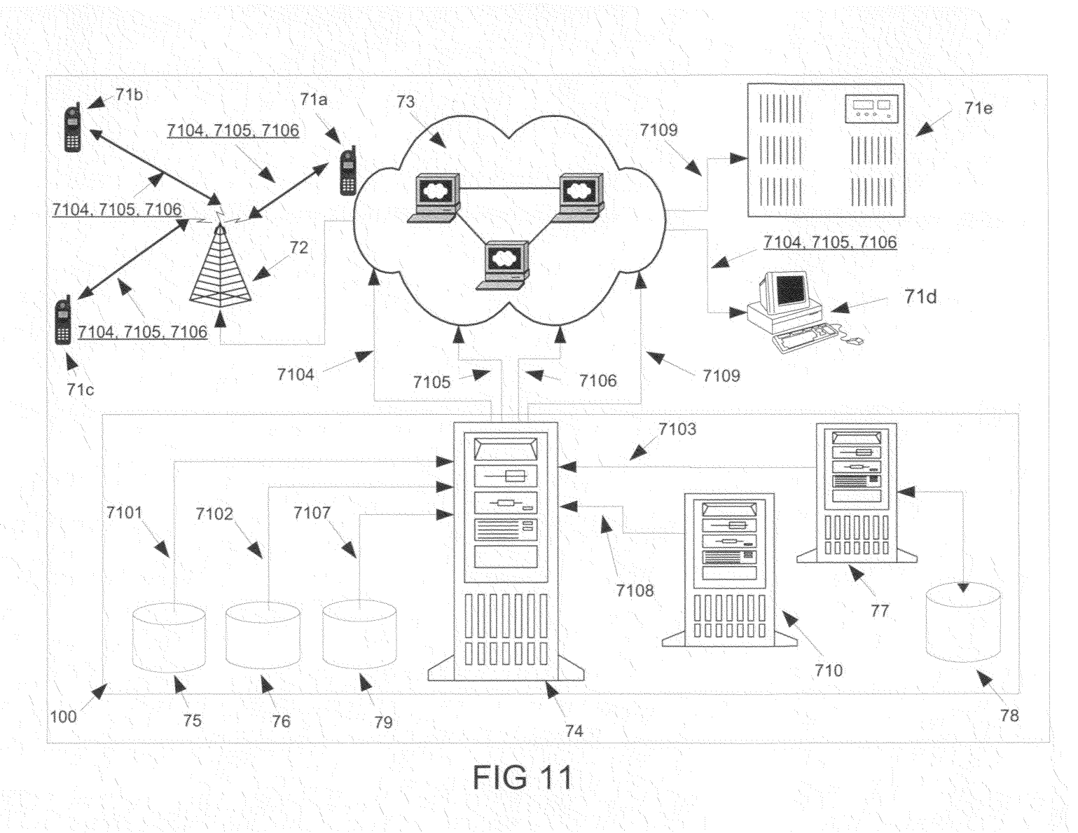

Traffic Reports and XML feed are further described in FIG. 11;

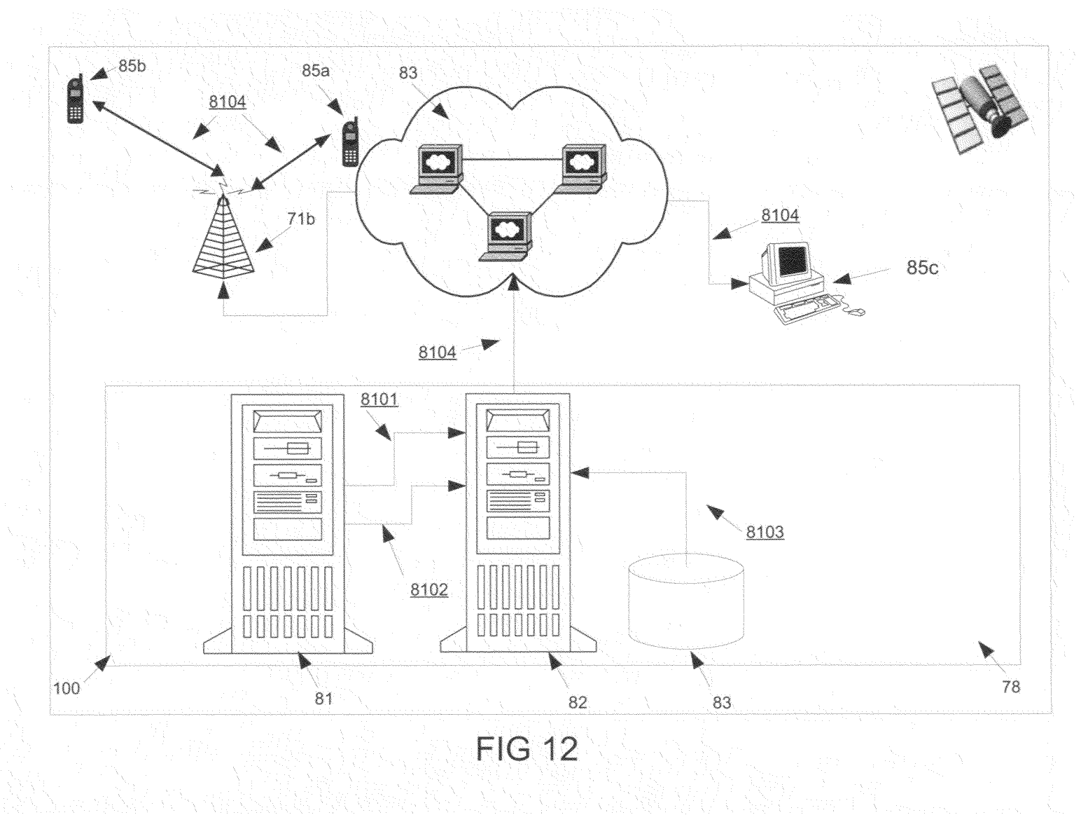

Traffic Alerts are presented by 1104, sent from the traffic information processing server 16 via the Internet to the telecommunication carrier which will deliver it to the designated mobile device 11b. Traffic Alerts is further described in FIG. 12;

Below is the list of the major functions performed by the traffic information processing server 16:
1. Register new user accounts;
2. Manage the users' accounts database;
3. Allow registered users to define and store routes;
4. Manage realtime travel information sent from plurality of users;
5. Manage Traffic Incidents Reports traffic information reports sent from plurality of users;
6. Manage the Current Traffic Information database CTIdb;
7. Manage the Historical Traffic Information database HTIdb;
8. Analyze and identify traffic congestion by comparing CTIdb to HTIdb;
9. Deliver traffic alerts to plurality of users;
10. Calculate optimal route requests from users from origination point to destination point using the CTIdb and the HTIdb to identify the most commonly used routes used by users to drive from the origination point to the destination point, which are currently not showing traffic congestions;
11. Manage and optimize network and resource utilization by dynamically reprogram configuration parameters of plurality of traffic management software clients;
12. Deliver by-request traffic reports containing realtime information;
13. Deliver realtime traffic information via XML feed;
14. Deliver by-request historical traffic reports and statistical analysis of historical traffic information;
15. Provide users with access to CTIdb via web services.

The traffic management software client's major functions include:
1. Read in predefined and reprogrammable interval location direction and speed information from a GPS receiver;
2. Store information from multiple such readings in the device memory with individual timestamps;
3. Communicate in predefined and reprogrammable interval the stored readings information to the traffic information processing server 16;
4. Accept user's traffic information active reports input;
5. Communicate active traffic information reports to traffic information processing server 16;
6. Receive traffic alerts information from traffic information processing server 16 and communicate it to the user visually and in an audio form;
7. Receive and process configuration parameters reprogramming from traffic information processing server 16;
8. Accept user request for a traffic report and communicate it to the traffic information processing server 16;
9. Receive traffic report information from traffic information processing server 16 and communicate it to the user visually and in an audio format;
10. Identify patterns indicating that the mobile communication device is not in a vehicle.

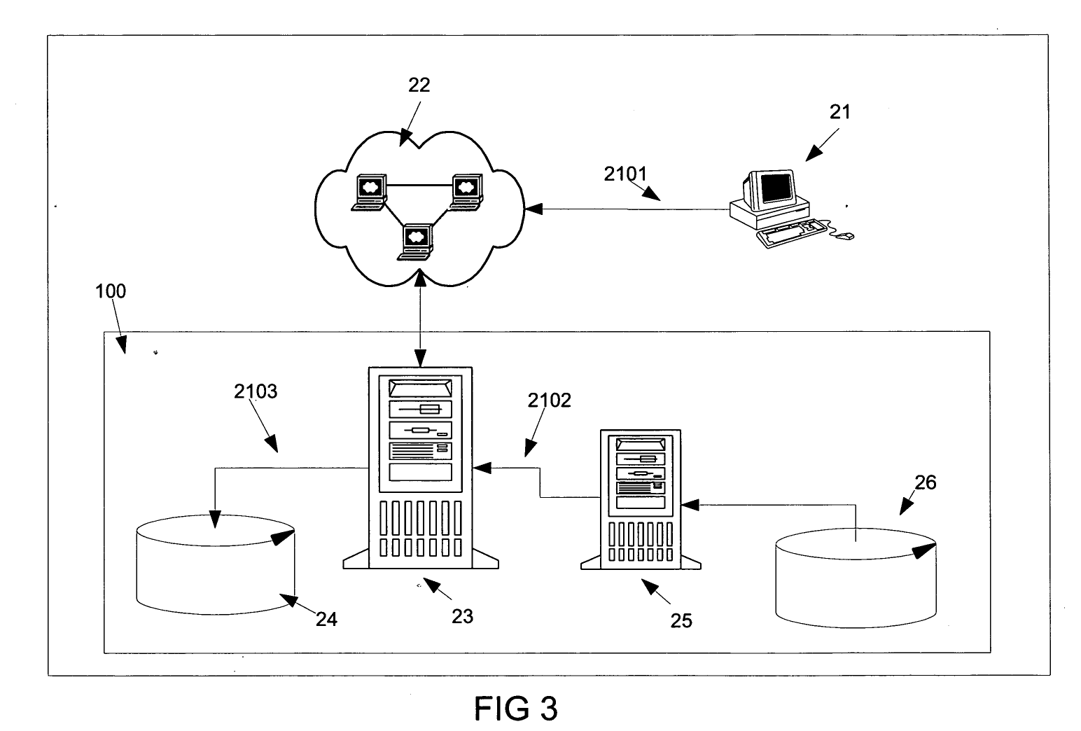

User account maintenance process is presented FIG. 3. User 21 is accessing the traffic information processing system 100 via the Internet 22. The account maintenance is done via the Users Community Host server 23. The users community host server is collecting information 2101 from the user which may include routes definitions, mobile software client configuration parameters and alert profile preferences.

The users community host server is using geographic information system services 2102 provided by a map server 25 using a geographic information system database 26 to fulfill all requests for route calculation and map images. The processed information from the user and the map server 2103 is then stored in the users database 24.

The routes definition process is define in the following section, assisted by the illustration in FIG. 4:

The user is defining routes from point O, representing the user's originating point, to point D, representing the user's destination point. The routes definition is done by defining Route Segments. Route Segment is a contiguous road section between 2 Segment Breakpoints, such as origination point, termination point, intersections, tollbooth etc. In the example illustrated in FIG. 4, the user defined 2 routes:
1. Route 1 comprise Route Segments R1a and R1b
   a. Route Segment R1a between Segment Breakpoints O and intersection A1B4
   b. Route Segment R1b between Segment Breakpoints A1B4 and D
2. Route 2 comprise Route Segments R2a, R2b, R2c and R2d
   a. Route Segment R2a between Segment Breakpoints O and A1B1
   b. Route Segment R2b between Segment Breakpoints A1B1 and A2B1
   c. Route Segment R2c between Segment Breakpoints A2B1 and A2B3
   d. Route Segment R2d between Segment Breakpoints A2B3 and D

For each segment, system will calculate expected trip time and allow the user to modify. The expected trip time calculation is based on combination of information from the history database and all other available information, such as but not limited to roads' speed limits, number of intersections, type of intersection traffic lights, stop, yield etc, direction of travel, turns types right/left/straight, time of day, day of week, holiday info, school zones etc.

The user will have the ability to name each route and each route segment, and the information will be stored in the database.

FIG. 5 is presenting the authentication process that is taking place at the beginning of each session between the mobile software client 31 and the traffic information processing system 100. User credentials user name and password, 3101 are transmitted by the mobile software client to the users community host server 33. The users community host server is validating the user credentials, loading the user profile 3102 from the users data base, 34, and sends back to the mobile software client a session initiation packet 3104 in an XML format. This session initiation packet contains a session identifier, initial runtime parameters and initial configuration parameters as stored in the user profile.

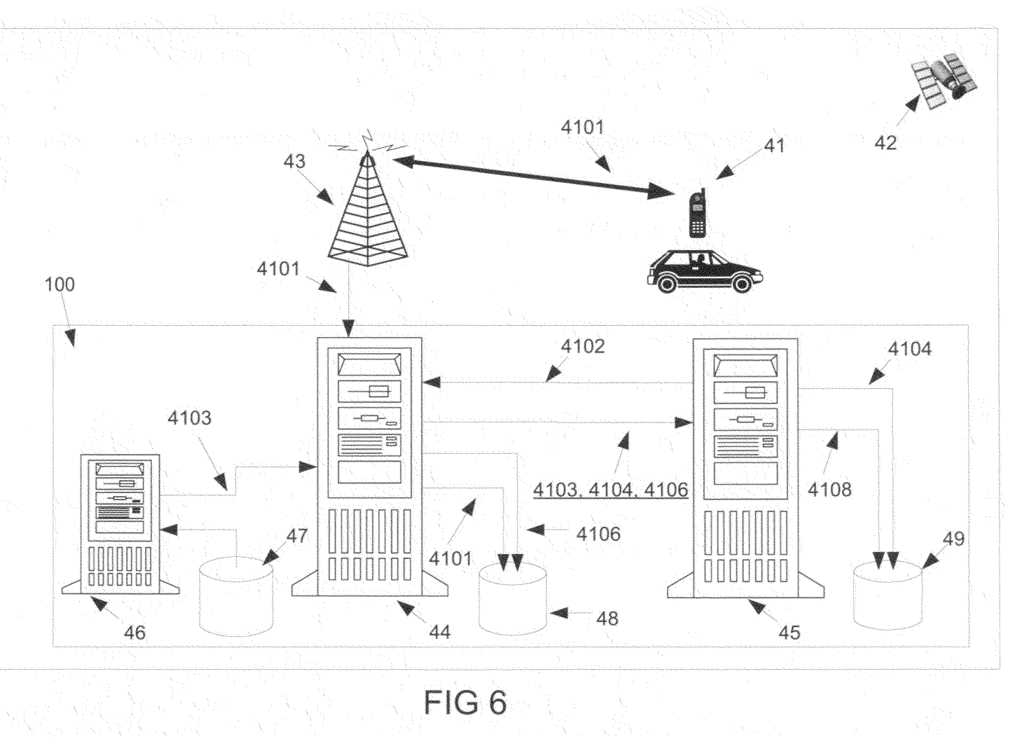

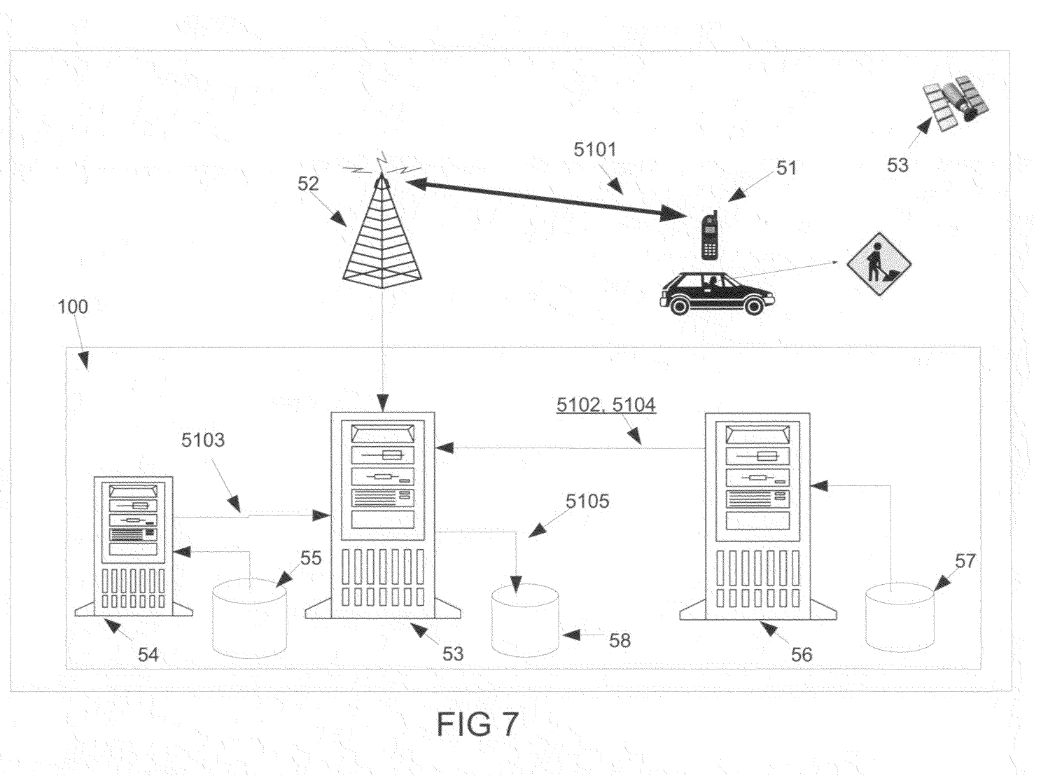

FIGS. 6 and 7 are presenting the two ways in which the system is obtaining and processing the traffic information inputs.

FIG. 6 is presenting the Passive Reporting process, in which speed and travel time information is automatically collected by the system with no need for user interaction. As the driver carrying the mobile device is traveling, the mobile software client 41 is constantly collecting the location, direction and speed information from the GPS receiver, which is collecting the information from the GPS satellite 42. The mobile software client validates the information and stores it in the device memory coupled with a timestamp of the reading. In a predefined and reprogrammable interval, the mobile software client creates a location direction and speed packet in XML format 4101. The location direction and speed packet comprise a creation timestamp, all the stored GPS readings from the device memory and the session identifier that was obtained from the users community host server when the session was initiated FIG. 5, 3104. The mobile software client sends it to traffic information processing system 100 via the telecommunication service provider 43.

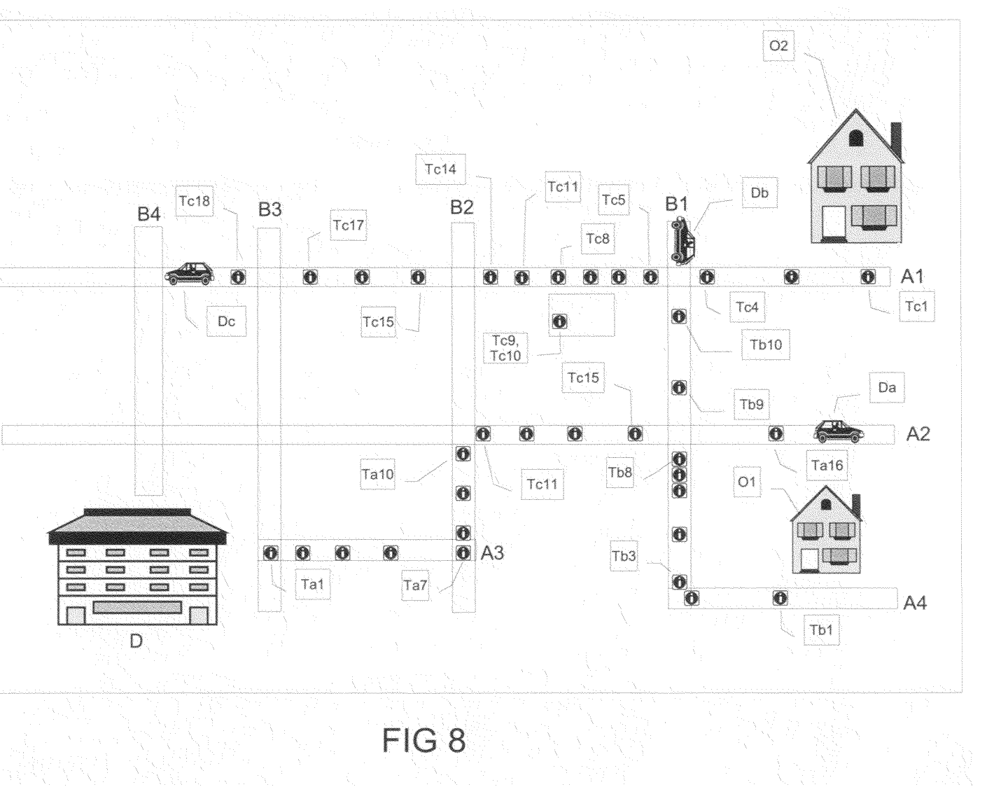

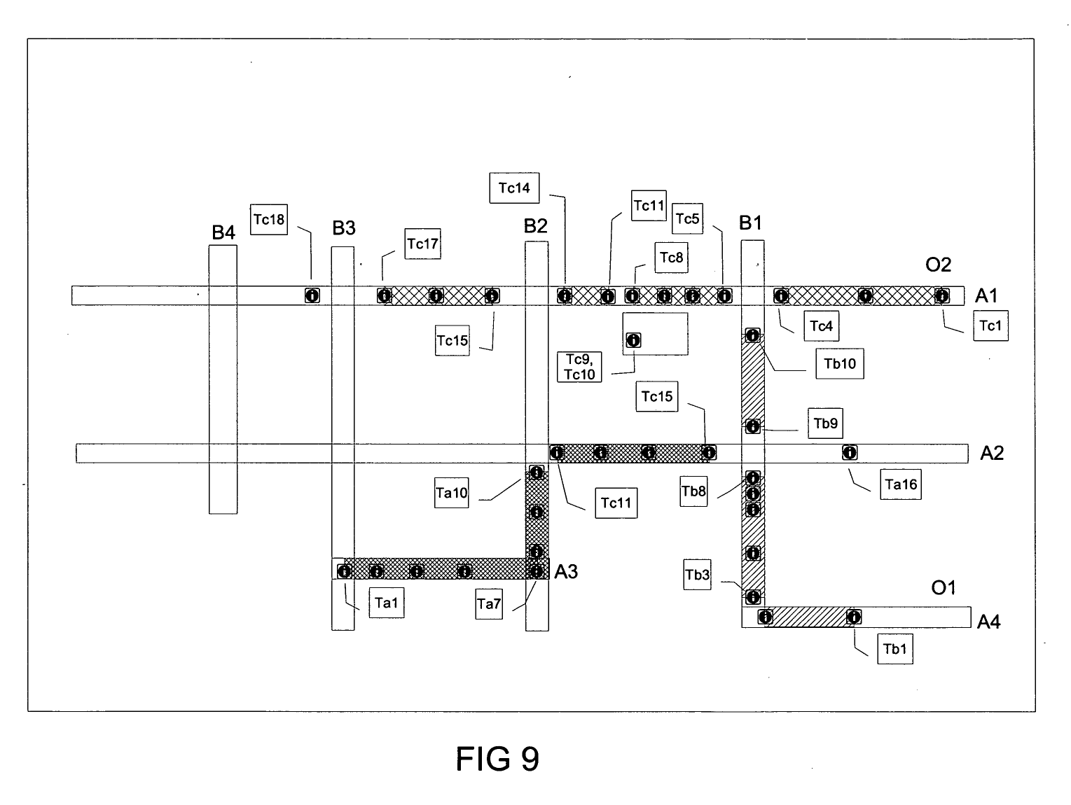

The data collection and analysis server, 44 is receiving the location direction and speed packet and performs the following activities:
(a) Validating the session identifier—if the data collection and analysis server is not identifying the session identifier occur when the location direction and speed packet is the first one in the current session, it will obtain session identifier validation 4102 from the users community host web server 45; for each GPS reading contained in the location direction and speed packet, the steps necessary to process the packet will be performed;
(b) Request a Road Segment Identifier Rsession identifier from the Map Server 46. The Map Server is looking up the road segment information in the geographic information system database 47 and sends back to data collection and analysis server the Rsession identifier 4103 comprise a unique segment ID, name, speed limit, geographical coordinates and other details that are stored in the geographic information system for this road segment. If the coordinates on the GPS reading are not corresponding to any road segment, the Rsession identifier will contain an “off-road” indication;
(c) If this is the first GPS reading for this session identifier for this Rsession identifier, data collection and analysis server will check if there is a complete segment reading from the previous session identifier/Rsession identifier combination. If there is, it will calculate the average speed. The process of calculating the average speed is detailed in the section for FIGS. 8 and 9. The calculated timing 4106 is recorded in the CTIdb 48;
(d) Update the CTIdb with the GPS reading information 4104;
(e) Send to the users community host server a packet containing the GPS reading 4104, the Rsession identifier 4103 and if applicable, segment timing 4106;
(f) the users community host server will record the user's location 4104 in the Users Database 49;
(g) the users community host server will determine current active route by matching the Rsession identifier 4103 to one of the predefined routes in the user's profile;
(h) If the data collection and analysis server did not send segment timing 4106 then process is done; otherwise,
(i) the users community host server will check if there is a complete Route Segment timing on the current user's route by checking that all the road segments on this route segment have timing from the current commute. If there is none, then process is done; otherwise,
(j) the users community host server will calculate the total time for the Route Segment be summing the timings from all the segments comprising the Route Segment, and record that total time 4108 in the user's profile;

FIG. 7 is presenting the Active Reporting process. The driver carrying the mobile device is identifying a traffic incident 52. Using the keyboard on the mobile device, the driver is pushing a key that was predefined in the user profile to report that type of incident. The mobile software client 51 is intercepting the user input, and sends the traffic information processing system 100 a Traffic Incident Report traffic information report in the form of an XML packet 5101 comprise the user input key value, the traffic information report's timestamp and an location direction and speed packet.

The data collection and analysis server 53 is receiving the traffic information report and performs the following activities:
(a) Validating the session identifier—if the data collection and analysis server is not identifying the session identifier when the location direction and speed packet is the first one in the current session, it will obtain session identifier validation 5102 from the users community host server 56;
(b) Request a Road Segment Identifier Rsession identifier from the Map Server 54. The Map Server is looking up the road segment information in the geographic information system database 55 and sends back to data collection and analysis server the Rsession identifier 5103 comprise a unique ID, name, speed limit, geographical coordinates and other details that are stored in the geographic information system for this road segment. If the coordinates on the location direction and speed packet are not corresponding to any road segment, the Rsession identifier will contain an “off-road” indication;
(c) The data collection and analysis server will check if the “off-road” indication is on, and discard the traffic information report if so; otherwise,
(d) request a Reliability Score from the users community host server 56, which is retrieving it from the user's database 57 and sends it back 5104 to data collection and analysis server, which is registering the traffic information report in the CTIdb 58.

The process of collecting and analyzing speed and trip time is continuous, and based on the data that is transmitted from multiple mobile software clients as described in Passive Reporting section for FIG. 6.

FIG. 8 and FIG. 9 are presenting the method of analyzing and calculating the speed for each segment on the map. In FIG. 8 vehicle Da was traveling from point A3B3 to point A3B2, then to point A2B2 and then to its current position. During the commute, the mobile software client operating from the mobile device in vehicle Da sent to the traffic information processing server 1 multiple location direction and speed packet packets Ta1 through Ta16 containing information collected from the GPS receiver that is connected to the mobile device. Vehicle Db was traveling from point A4O1 to A4B1, then to its current position, and sent location direction and speed packet Tb1 through Tb10. Vehicle Dc traveled from A1O2 to its current position reporting location direction and speed packet Tc1 through Tc18.

The method for calculating the speed along the segments is presented in FIG. 9 and comprises the following steps:
1. Identify the first and the last GPS reading on a given segment.
2. Analyze and filter out “off-road” GPS readings:
   a. The road section will be split into 2 section
   b. First GPS reading of the first section is the first GPS reading of the original section
   c. Last GPS reading of the first section is the last GPS reading before the first “off-road” GPS reading
   d. First GPS reading of the second section is the first GPS reading after the last “off-road” GPS reading
   e. Last GPS reading of the second section is the last GPS reading of the original section
   f. Discard all “off-road” GPS readings
3. Calculate the average speed on each section
   a. Find the distance from the first GPS reading on the section to the last GPS reading on the section by adding the distances between all the consecutive GPS readings between the first and the last readings
   b. Calculate the elapsed time by subtracting the timestamp of the first GPS reading on the section from the timestamp of the last GPS reading on the section
   c. Divide the calculated distance by the calculate time to find the average vehicle distance in the section
4. Each time a segment speed is calculate from data received from a vehicle, the average speed for that segment will be adjusted, factoring in the age of previous calculated speeds. Higher age decreases their weight in the average calculation.

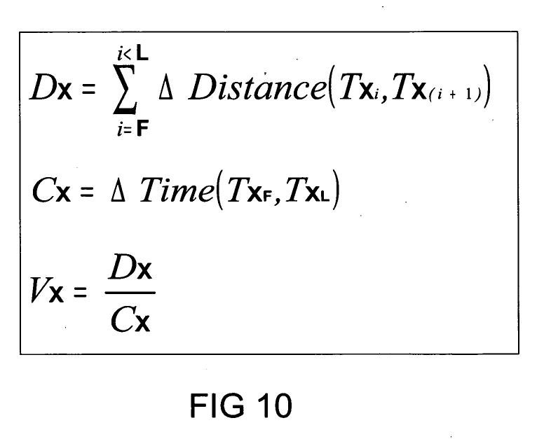

Below is an example for applying the method on the GPS readings received from vehicle Dc Tc1 to Tc18:
1. Identify the first and the last GPS reading on a given segment:
   For segment A1O2-A1B1, first is Tc1 and last is Tc4,
   For segment A1B1-A1B2, first is Tc5 and last is Tc14,
   For segment A1B2-A1B3, first is Tc15 and last is Tc17
2. Analyze and filter out “off-road” GPS readings:
   a. The road segment will be split into 2 subsections:
      segment A1B1-A1B2 is split into A1B1-A1B1.5 and A1B1.5-A1B2
   b. For the first subsection, first GPS reading is the first GPS reading of the original segment and the last GPS reading is the last GPS reading before the first “off-road” GPS reading:
      For subsection A1B1-A1B1.5, first is Tc5 and last is Tc8
   c. For the second subsection, first GPS reading is the first GPS reading after the last “off-road” GPS reading and the last GPS reading is the last GPS reading of the original segment:
      For subsection A1B1.5-A1B2, first is Tc11 and last is Tc14
   d. Discard all “off-road” GPS readings:
      Tc9 and Tc10
3. Calculate the average speed on each section
   a. Find the distance from the first GPS reading on the section to the last GPS reading on the section by adding the distances between all the consecutive GPS readings between the first and the last readings
   b. Calculate the elapsed time by subtracting the timestamp of the first GPS reading on the section from the timestamp of the last GPS reading on the section
   c. Divide the calculated distance by the calculate time to find the average vehicle distance in the section
   Using the formulas in FIG. 10, calculate as follows.
   Inputs:
   X=Route identification letter ‘a’, ‘b’, or ‘c’ from FIGS. 8 and 9
   F=The number of the first GPS reading in the segment
   L=The number of the last GPS reading in the segment
   Outputs for segment A1O2-A1B1 F=1, L=4, X=‘c’:
   Dc=distance between Tc1 to Tc4
   Cc =the time elapsed between Tc1 to Tc4
   Vc=the average speed for this segment.
   Dc, Cc, and Vc are stored in the CTIdb associated to segment A1O2-A1B1.
   Outputs for segment A1B1-A1B1.5 F=5, L=8, X=‘c’:
   Dc=distance between Tc5 to Tc8
   Cc=the time elapsed between Tc5 to Tc8
   Vc=the average speed for this segment.
   Dc, Cc, and Vc are stored in the CTIdb associated to segment A1B1-A1B1.5.
   Outputs for segment A1B1.5-A1B2 F=11, L=14, X=‘c’:
   Dc=distance between Tc11 to Tc14
   Cc=the time elapsed between Tc11 to Tc14
   Vc=the average speed for this segment.
   Dc, Cc, and Vc are stored in the CTIdb associated to segment A1B1.5-A1B2.
   Outputs for segment A1B2-A1B3 F=15, L=17, X=‘c’:
   Dc=distance between Tc15 to Tc17
   Cc=the time elapsed between Tc15 to Tc17
   Vc=the average speed for this segment.
   Dc, Cc, and Vc are stored in the CTIdb associated to segment A1B2-A1B3.

FIG. 11 is presenting the process of providing traffic reports to requesting users 71a, 71b, 71c, 71d and 71e. The users community host server 74 will obtain user profile 7102 from the users' database 76 in order to create a report customized to the user's specific routes that are stored in the profile. For each of the routes that are in the profile and are included in the request, the users community host server will obtain from the CTIdb 75 the average speed and average travel time 7101 for each of the segments included in the route. In case the requested report is a graphic map, the commuters community host web server will obtain the map from the map server 77 which will use the geographic information system db 78 in order to generate the requested map and send it 7103 back to the users community host server.

In the current invention 3 types of reports are supported: Textual reports, voice reports and graphic reports. The voice reports are text reports converted to voice using standard text-to-speech technology to generate a voice file, in the format that is supported by the mobile device type used by the requesting user.

In FIG. 11, report 7104 is a text report, 7105 is a graphic report, and 7106 is a voice report. The users community host server is sending the reports to the end users. For mobile users, the report will arrive via a wide area network such as the Internet 73 to the telecommunication provider gateway 72 and from there to the end users. The medium that the telecommunication provider is sending the information to the end user is dependent solely on the technology used by the provider. For the PC user 71d the reports will be sent from the network directly to the user's terminal.

Realtime traffic information XML stream 7109 is delivered to computer systems of paying customers 71e, and is based on geographical area rather than on predefined routes. The users community host server will obtain the customer information 7107 from the Customers Database commuters data base, 79. The information includes the customized XML schema for the requesting customer, and the geographical area that updates are requested for. During its operation, the data collection and analysis server 710 is feeding the commuters community host web server with the traffic updates 7108 that were written into the CTIdb as detailed in FIG. 7, 5105 and FIG. 6, 4106. The users community host web server will filter out updates that are not falling into the geographical area that the XML feed should cover and create the XML feed using the customized schema to be delivered to the customer's computer.

FIG. 12 is presenting the alerting functionality. Traffic information reports 8101 that are received from users via Active Reporting detailed in FIG. 7 are sent from the data collection and analysis server 81 to the users community host server 82. In addition, segment timings 8102 are sent to the users community host server from the data collection and analysis server as detailed in FIG. 6, 4106.

For each active user, the users community host server will determine based on the user's profile 8103 that was loaded from the User's DB 83 if alert should be sent, and if so, the users community host server will send the alert 8104 to the applicable users 85a, 85b or 85c.

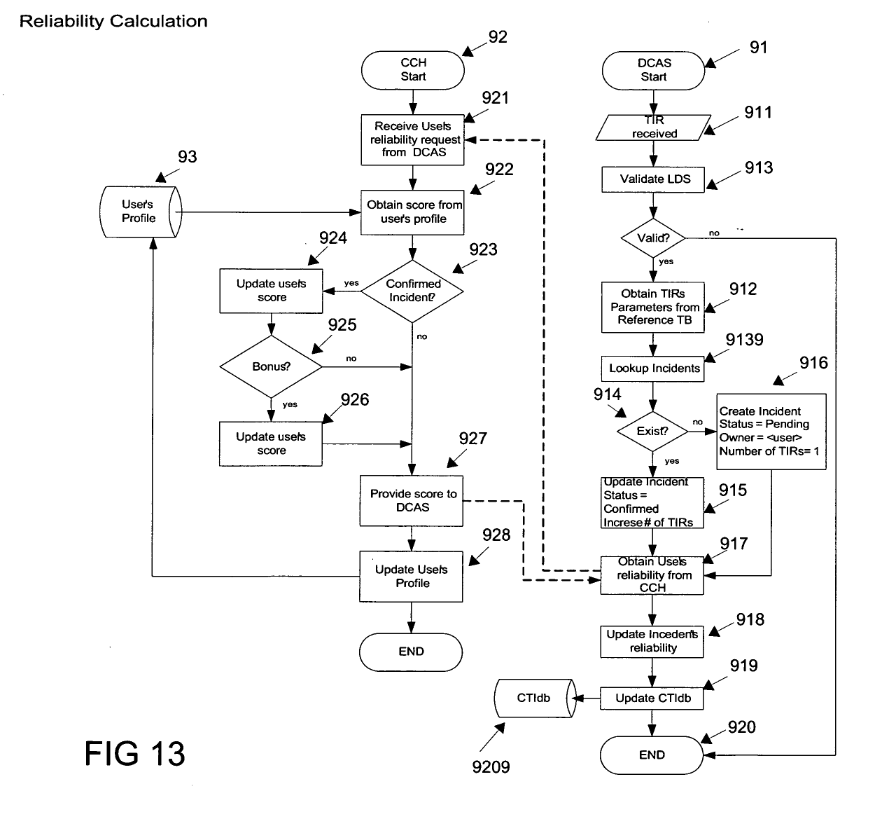

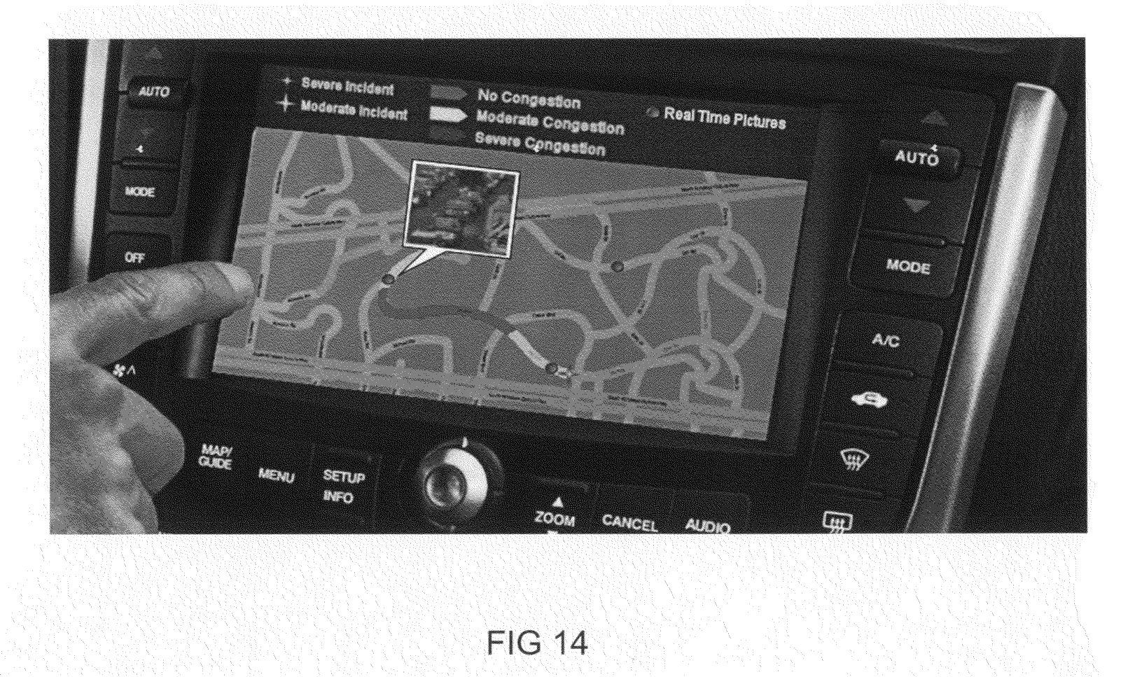

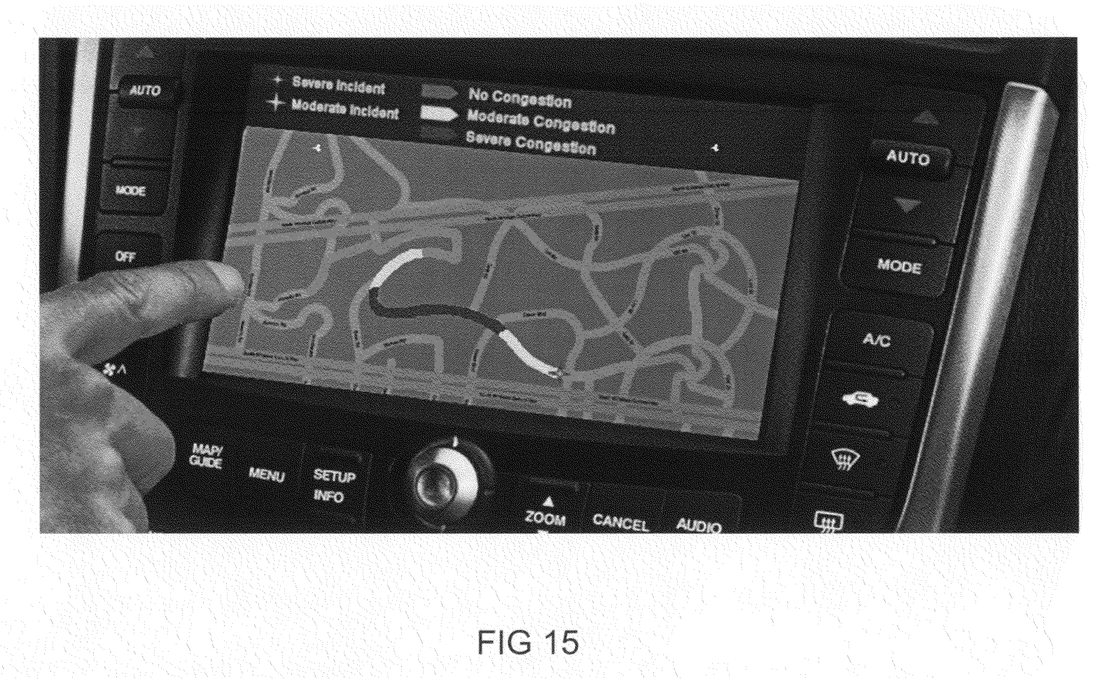

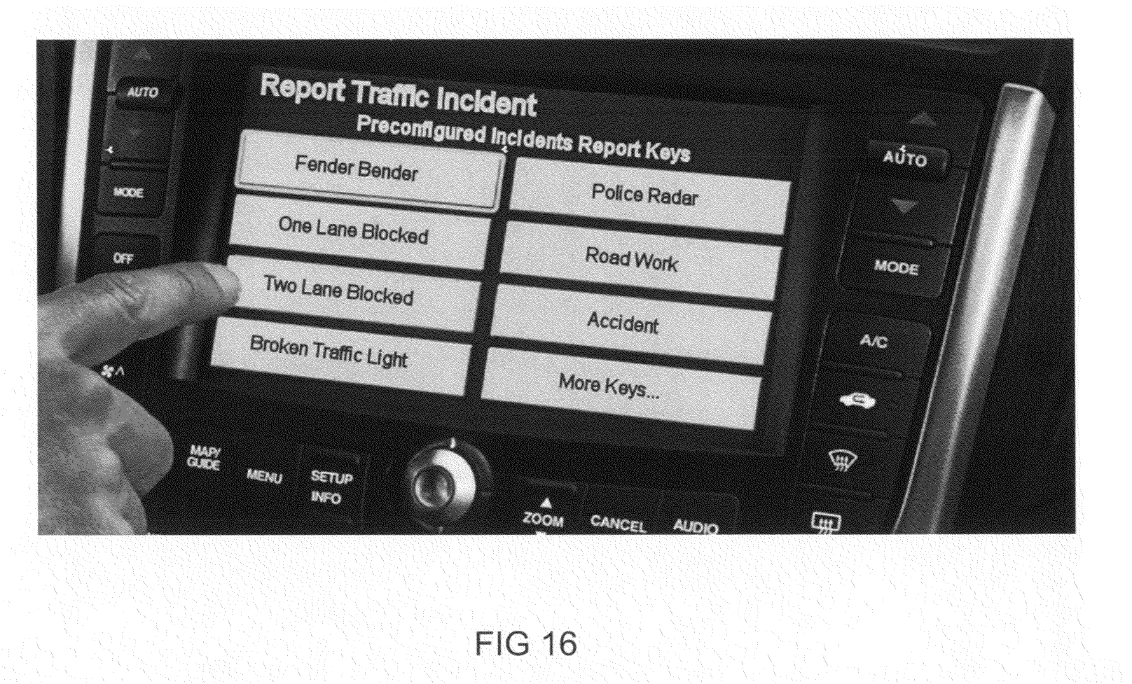

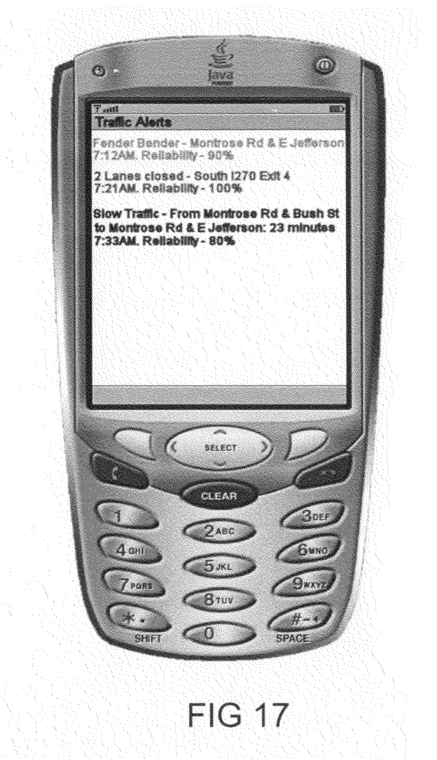

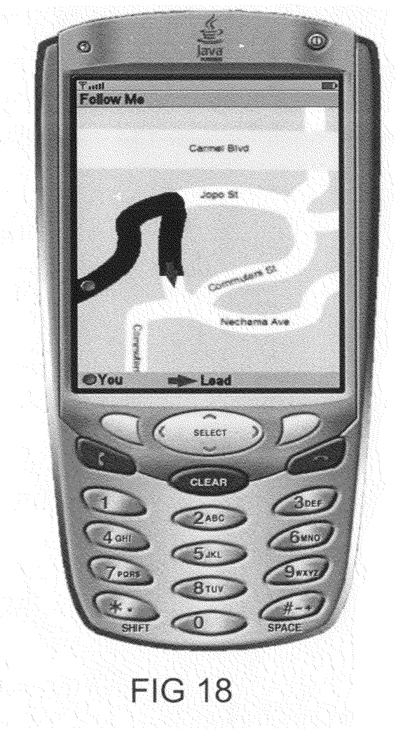

FIG. 13 provides a first exemplary flow chart of a reliability calculation. As discussed above, the reliability calculation is utilized to score a user's report of an accident and determine whether to update the database based on the past history of the user's reliability in reporting an accident.

FIG. 14 shows an exemplary graphical user interface in accordance with aspects of the invention. In FIG. 14, an exemplary legend is used to indicate severe traffic incidents and moderate incidents. Colors are used to show sever congestion, moderate congestion, and no congestion. In addition, the display may include either a real time picture of video by simply tapping on a portion of the road to show what traffic is doing over that stretch of road. The video may be obtained from a traffic camera provided by the municipality or by a video/picture reported by a user parked in the traffic. The red dots on the display or other suitable icon my be utilized to show locations where a picture and/or video image is available. In exemplary embodiments, when the user starts up his car for his daily commute, the system in accordance with aspects of the invention may suggest one of a plurality of alternate routes for the user to take to work. While this example uses the route to work, any destination programmed by the user may similarly be utilized. By tracking the speed of various mobile communication devices along alternate routes, and analysis of routes stored in the system's history DB, the system may dynamically determine the fastest route for a user to use in his daily commute. This sends more motorists to those routes that are less congested at any given time, more evenly spreading the traffic across the region to utilize the available roads more efficiently. The system in accordance with the present invention also allows the users to minimize their travel times.

FIG. 15 shows a similar display as FIG. 14 with the real-time picture option turned off.

FIG. 16 shows an exemplary graphical user interface to quickly and easily report a traffic incident in accordance with the present invention. Sample preconfigured incident report keys may include: a) fender bender, b) one lane blocked c) two lanes blocked, d) broken traffic light, d) police radar, e) road work, f) major accident, and/or additional reporting. The traffic incident report may also include a mechanism for a user to submit a photograph or video of the accident for broadcast to other individuals stuck in the traffic. In the embodiment presented in FIGS. 14, 15 and 16, the mobile software client that is installed on the user's mobile device is communicating with the vehicle's in-dash display in order to provide larger display, as well as utilize the touch screen input capabilities built into the in-dash display, thus enhancing the user experience.

FIG. 17 is a cell phone showing traffic alerts which may also be distributed in text form as opposed to a full graphic format. In this form, the traffic alerts may simply provide text based updates on traffic conditions along the user's expected route. The user may select these text alerts to receive further text based information or to switch to a graphic display. By selecting a traffic incident or hitting another button, the user may switch back to the text based display screens discussed above. See FIG. 18, for example.

What is claimed is:

1. A traffic incidents processing system comprising:
a central computer system, operatively connected to a wide area network such as the Internet;
at least two mobile communication devices, capable of determining their geographical location, operatively connected to a wide area network such as the Internet; and
a mobile client software, capable of operating on said mobile communication devices, and capable of interfacing with said central computer system for reporting traffic incidents.

2. The system of claim 1, further comprising:
a users' web server and a web site, capable of collecting non-identifying information from a plurality of users and storing this information in a user database;
a users database, for storing account information for each user and user profile information as set by the user;
at least one traffic information collecting server, capable of collecting, analyzing and storing traffic information from a plurality of mobile communication devices;
a database for storing real-time traffic information collected by said collecting server, such as travel time per road segment, traffic incidents location and type;
a database for storing historical traffic information; and
a database for storing a history of routes traveled by the users of the system; and
a customers web server and a web site, capable of providing access to plurality of users, to the traffic information stored in the said database for storing real-time traffic information and the historical traffic information databases, and present the information to the users in a graphical format.

3. The system of claim 2, wherein said user profile may include:
information about the type of mobile communication device the user has; and
routes the user is regularly commuting on;
traffic incidents reports quick keys assignment, to be used by the user while operating the mobile client software; and
alerts preferences parameters, defining what type of alerts the user is interested in receiving and what form of alerts the user is preferring to receive.

4. The system of claim 1, further comprising:
a display unit screen, an input unit keyboard, an audio unit speaker; and
a microprocessor, serving to execute software code; and
a memory unit;
a Global Navigation Satellite System (GNSS) receiver unit such as a GPS receiver, connected to the microprocessor, serving to provide location information in the form of geographical coordinates, travel direction information and travel speed information; and
a mechanism for communicating with the central computer system via a network for providing dynamic traffic alerts.

5. The system of claim 1, wherein the client is capable of interfacing with the user of the said mobile communication device in order to obtain information from the user, transmit this information to the central computer system via a network, obtain information from the said central computer system and communicate this information back to the user.

6. The system of claim 5, wherein the client is capable of obtaining the real-time position, direction and speed information from the said GNSS receiver unit in order to transmit this information to the central computer.

7. The system of claim 5 wherein the information obtained from the central computer system comprises the user profile information.

8. The system of claim 6 wherein the user interface allows a user to input information via a textual interface and/or graphical interface and/or voice recognition interface, and communicate back to the user via textual interface and/or graphical interface and/or voice interface using text to speech capability.

9. The system of claim 8 including a traffic information report created by the user which indicates type of the traffic incident and a timestamp indicating the time the traffic information report was sent and location information indicating where the traffic information report was detected.

10. The system of claim 2, wherein the system is capable of calculating the most frequently traveled route from any origination point to any destination point by analyzing the history of traveled routes stored in said database.

11. The system of claim 2, wherein the system is capable of calculating the time of travel for a given route from any origination point to any destination point by analyzing the historical traffic information stored in said database to determine the expected speed of traffic in such route and the real-time traffic information known to the system to adjust the expected speed according to the current traffic conditions existing in the route.

12. The system of claims 10 and 11, wherein the system is capable of receiving a user request for optimal route from any origination point to any destination point and determine the optimal route by comparing the time of travel of all the known routes from the origination point to the destination point and selecting the route with the shortest time of travel.

13. The system of claim 8, wherein the system is capable of accepting a user request for optimal route from the user's current position or any other origination point to a destination point, transmit the request to the central processing system, receive the optimal route from the central processing system, and communicate it back to the user.
